(19) United States
(12) Patent Application Publication
(10) Pub. No.: US 2008/0317531 A1
(43) Pub. Date: Dec. 25, 2008

(54) IMAGE FORMING APPARATUS

(75) Inventors: Makoto KANAI, Saitama (JP); Akinori ONO, Saitama (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/055,563

(22) Filed: Mar. 26, 2008

(30) Foreign Application Priority Data
Apr. 26, 2007 (JP) 2007-117281

(51) Int. Cl. G03G 15/00

(52) U.S. Cl. 399/381

(57) ABSTRACT

An image forming apparatus including: a recording medium transport path along which a recording medium is transported; a pair of first rollers that are provided at an upstream side in a recording medium transporting direction with respect to the recording medium transport path and that feed the recording medium into the recording medium transport path; a pair of second rollers that are provided at a downstream side in the recording medium transporting direction with respect to the recording medium transport path and that receive the recording medium transported by the recording medium transport path; a recording medium transport stopping section that stops transporting of the recording medium on the recording medium transport path; and a path opening and closing member that opens the recording medium transport path is provided.

### CROSS-REFERENCE TO RELATED APPLICATIONS

This application is based on and claims priority under 35 USC 119 from Japanese Patent Application No. 2007-117281 filed Apr. 26, 2007.

### BACKGROUND

### Technical Field

The present invention relates to an image forming apparatus, and particularly to an image forming apparatus to which is added a function such that a user may specify a cause of generation of a paper wrinkle which is one of troubles occurred when using of the image forming apparatus.

### SUMMARY

In accordance with an aspect of the invention, there is provided an image forming apparatus including: a recording medium transport path along which a recording medium is transported; a pair of first rollers that are provided at an upstream side in a recording medium transporting direction with respect to the recording medium transport path and that feed the recording medium into the recording medium transport path; a pair of second rollers that are provided at a downstream side in the recording medium transporting direction with respect to the recording medium transport path and that receive the recording medium transported by the recording medium transport path; a recording medium transport stopping section that stops transporting of the recording medium on the recording medium transport path; and a path opening and closing member that opens the recording medium transport path.

### BRIEF DESCRIPTION OF THE DRAWINGS

Exemplary embodiments of the invention will be described in detail with reference to the following figures, wherein:

FIG. 1 is a schematic side elevational view showing a structure of an image forming apparatus in accordance with a first exemplary embodiment of the invention;

FIG. 2 is a schematic side elevational view showing a state in which a cover of the image forming apparatus in accordance with the first exemplary embodiment of the invention is opened;

FIGS. 3A and 3B are plan views showing a transport unit side of the image forming apparatus in accordance with the first exemplary embodiment of the invention, in which FIG. 3A is a view showing a case that a cause of a paper wrinkle exists in a registering roll side, and FIG. 3B is a view showing a case that the cause of the paper wrinkle exists in a heat roll side of a fixing apparatus;

FIG. 4 is a schematic side elevational view showing a state in which a cover of an image forming apparatus in accordance with a second exemplary embodiment of the invention is opened;

FIG. 5 is a schematic side elevational view showing a state in which a cover of an image forming apparatus in accordance with a third exemplary embodiment of the invention is opened;

FIG. 6 is a schematic side elevational view showing a state in which a cover of an image forming apparatus in accordance with a fourth exemplary embodiment of the invention is opened; and

FIG. 7 is a plan view showing a transport unit side of an image forming apparatus in accordance with a fifth exemplary embodiment of the invention;

### DETAILED DESCRIPTION

A description will be in detail given below of exemplary embodiments of the invention shown in the accompanying drawings. In this case, in each of the drawings, elements arranged per colors yellow (Y), magenta (M), cyan (C) and black (K) may have signs “Y”, “M”, “C” and “K” attached to reference numerals.

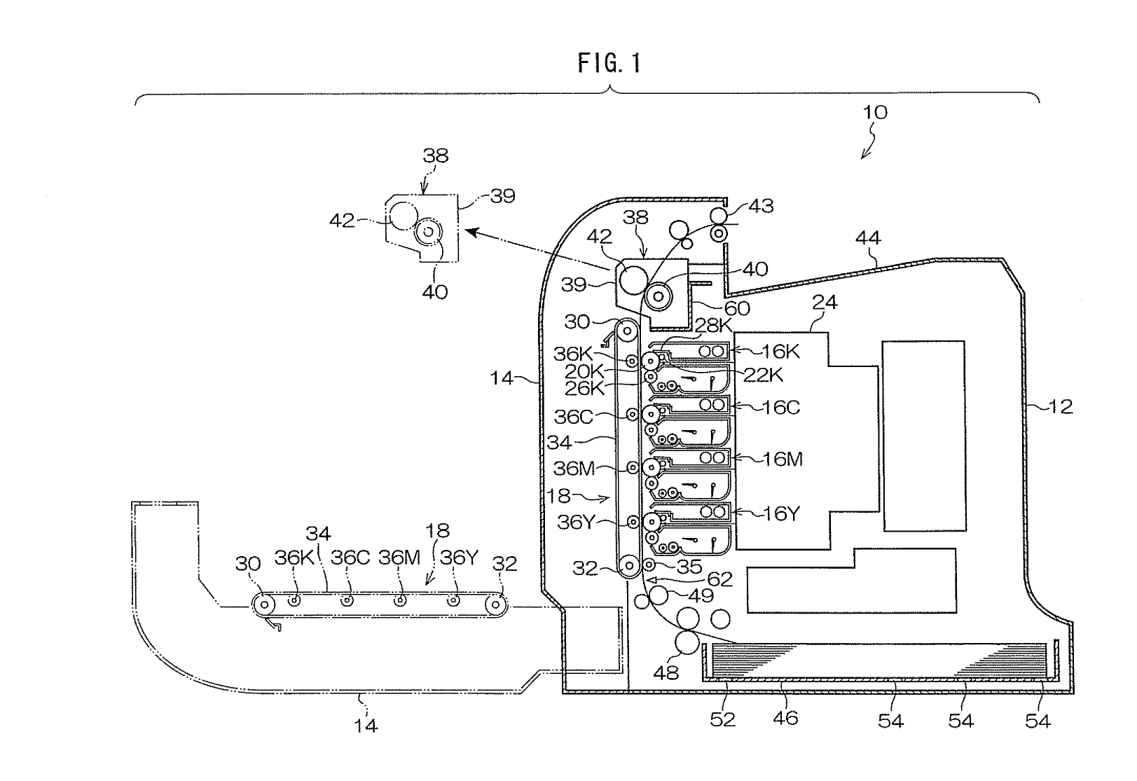

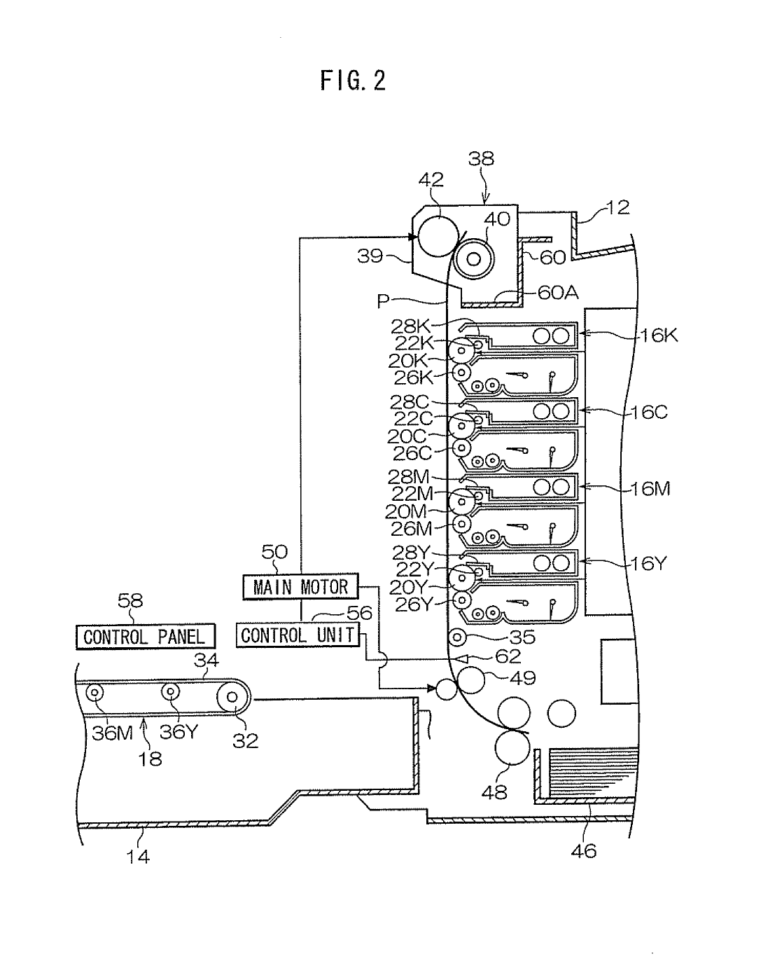

A description will be first given of an outline of an image forming apparatus 10 in accordance with the exemplary embodiments of the invention. As shown in FIGS. 1 and 2, the image forming apparatus 10 includes a main body frame 12 detachably accommodating image carriers (photosensitive bodies) 20 and developing units 16, and a cover 14 which is rotatable with respect to the main body frame 12.

A carrier unit 18 provided with a transport belt 34 capable of adsorbing and transporting a recording paper P is attached to the cover 14, and the structure is made such that the carrier unit 18 faces to the image carrier 20 or is away from the image carrier 20 by rotating the cover 14. The recording paper P in which a jamming occurs may be removed or replace consumable supplies may be exchanged by rotating the cover 14 so as to open with respect to the main body frame 12.

The developing unit 16 is provided with the roll-shaped image carrier 20 on which a latent image is formed, an charging roll 22 uniformly charging a surface of the image carrier 20, a developing roll 26 selectively transferring a toner to the latent image formed on the image carrier 20 so as to make visible, and a cleaning member 28 coming into sliding contact with the image carrier 20 after the toner image is transferred and cleaning the toner remaining on the image carrier 20.

The image carrier 20 includes a photosensitive layer on a surface (a peripheral surface), the surface (the peripheral surface) is exposed by a laser beam (an image light) irradiated from an optical box 24 after the surface (the peripheral surface) is uniformly charged by the charging roll 22, and an electrostatic latent image (an image) is formed on the basis of decreasing of an electric potential of the exposed portion. In this case, the charging roll 22 is brought into contact with the image carrier 20, an electric voltage is applied therebetween, and discharging occurs within a small gap near the contact portion, thereby the charging roll 22 substantially uniformly charges the surface (the peripheral surface) of the image carrier 20.

The optical box 24 makes the laser beam, on the basis of an image data, scan on the surface (the peripheral surface) of the image carrier 20, and forms an electrostatic latent image on the basis of the image data on the surface (the peripheral surface) of the image carrier 20. In this case, as the optical box 24, there may be considered another system in which light emitting devices such as LED are arranged so as to be turned on or off on the basis of the image data, in addition to the system of scanning the laser beam.

The developing roll 26 is arranged so as to come close to and face to the image carrier 20, and is structured such that a developing bias voltage is applied between the developing roll 26 and the image carrier 20. Accordingly, a developing bias electric field is formed between the developing roll 26 and the image carrier 20, and the toner having an electric charge is transferred to the exposed portion on the image carrier 20 so as to form a visible image.

On the other hand, the carrier unit 18 is provided with a transport belt 34 which is supported in a tensional manner to at least a drive roll 30 and a driven roll 32, and a surface of the transport belt 34 is charged, at the same time when a recording paper P is fed onto the transport belt 34, by an electrostatic adsorption roll 35 provided near the driven roll 32. Accordingly, the recording paper P is adsorbed in an electrostatic manner to the transport belt 34, and is transported in accordance with a rotating movement of the transport belt 34. In this case, the electrostatic adsorption roll 35 may be provided if necessary.

Further, plural (four corresponding to each colors mentioned below) transfer rolls 36 are arranged at predetermined positions between the drive roll 30 and the driven roll 32, in an inner surface side of the transport belt 34 so as to be spaced at a predetermined intervals therebetween.

The transfer roll 36 is structured such as to face to the image carrier 20 while the transfer roll 36 and the image carrier 20 sandwich the transport belt 34 at a time when the cover 14 is closed. The transfer roll 36 transfers a toner image (an unfixed image) which is on the surface of the image carrier 20 onto the recording paper P adsorbed and transported onto the transport belt 34 so as to pass through, by forming a transfer electric field between the image carrier 20 and the transfer roll 36.

The developing units 16 are arranged in a vertical direction, for example, in the order of the yellow (Y), the magenta (M), the cyan (C) and the black (K) in such a manner that a full color printing may be carried out, and a fixing device 38 is arranged in a downstream side (an upper portion of the main body frame 12) in a transporting direction of the recording paper P (hereinafter, refer to as “transporting direction”), and a far side of the main body frame 12 than a transfer surface of the image carrier 20.

The fixing device 38 is provided with an substantially box-shaped casing 39, and a heat roll 40 and a pressure roll 42 in which peripheral surfaces are faced to each other and pressure contacted (nipped) at a predetermined pressure are accommodated within the casing 39. The toner image is fixed on the recording paper P by sandwiching the recording paper P by the heat roll 40 and the pressure roll 42 and heating and pressurizing the unfixed toner image transformed onto the recording paper P.

Although an illustration is omitted, gears are provided in the heat roll 40 and the pressure roll 42. When a driving force is transmitted to a drive gear arranged in an outer side of the casing 39 from a main motor 50 which drives a drive system, provided within the image forming apparatus 10, the driving force is transmitted to the gears of the heat roll 40 and the pressure roll 42 from the drive gear, and the heat roll 40 and the pressure roll 42 are driven.

A support portion 60 supporting the fixing device 38 is arranged within the image forming apparatus 10. A mounting surface 60A on which a bottom surface of the substantially box-shaped casing 39 constructing the fixing device 38 is mounted is formed in the support portion 60, and the fixing device 38 is detachable with respect to the support portion 60. In other words, the fixing device 38 is attached to the image forming apparatus 10 via the support portion 60, and is structured such that the fixing device 38 stays within the image forming apparatus 10 and is exposed from the image forming apparatus 10, at a time of opening the cover 14.

The recording paper P on which the toner image is fixed by being heated and pressurized by the fixing device 38 (the heat roll 40 and the pressure roll 42) is discharged onto a paper discharge tray 44 by a paper discharge roller 43. Further, the surface (the peripheral surface) of the image carrier 20 after finishing the transfer of the toner image to the recording paper P is cleaned by the cleaning member 28, then, waiting for the next image forming process.

Further, a detachable paper cassette 46 is provided in a lower portion of the main body frame 12. The paper cassette 46 may be drawn out in an inverse direction to a direction in which the recording paper P is fed, and the recording paper P can be supplied appropriately therein.

The paper cassette 46 is provided with a sensor 52 detecting presence or not of the recording paper P, and a sensor 54 detecting a size of the recording paper P. The sensors 52 and 54 are both connected to a control unit 56, and in a case that the recording paper P is not accommodated within the paper cassette 46 or in a case that the recording paper P accommodated within the paper cassette 46 is different from a size which a user designates by a control panel 58 or the like, the control panel 58 notifies the user of it.

Further, a pair of paper feeding rollers 48 feeding the recording paper P from an inner side of the paper cassette 46 are provided in a downstream side end portion in a transporting direction of the paper cassette 46, and the recording paper P fed from the pair of paper feeding rollers 48 is fed to an adsorption transport surface of the transport belt 34 at a predetermined timing by registering rolls 49, and is transported to a transfer position of the toner image of each of the colors.

Further, the images formed on the image carrier 20 are transferred to the recording paper P one by one by the transfer rolls 36, and the recording paper P is fed in the fixing device 38. At this time, a path, which is constructed by the transport belt 34 and the image carrier 20 and along which the recording paper P is transported, forms a paper transport path. The structure is made such that when the cover 14 is opened, the carrier unit 18 is moved together with the cover 14, and the paper transport path is opened.

A sensor 62 is provided at a position in a downstream side in the transporting direction than a position in which the registering rolls 49 are provided in the paper transport path. The sensor 62 is connected to the control unit 56, and it is determined, on the basis of an elapsed time after a leading end of the recording paper P is detected by the sensor 62 that the leading end of the recording paper P enters into a nip portion between the heat roll 40 and the pressure roll 42 of the fixing device 38.

The registering rolls 49 are structured such that a driving force is transmitted from a main motor 50 provided within the image forming apparatus 10 in the same manner as the heat roll 40 and the pressure roll 42. Accordingly, when the driving of the main motor 50 is stopped, the rotational drive of the registering rolls 49 is stopped together with the heat roll 40 and the pressure roll 42.

In the image forming apparatus 10 having the structure mentioned above in which a device check operation is operatable, in a case that the paper wrinkle is generated in the recording paper P discharged from the image forming apparatus 10, the user carries out a paper wrinkle determination Mode A from the control panel 58 of the image forming apparatus 10 or a user interface screen of a personal computer. Accordingly, the paper wrinkle determination Mode A is executed in the image forming apparatus 10.

When the paper wrinkle determination Mode A is executed, presence or not and the size of the recording paper P within the paper cassette 46 are detected by the sensors 52 and 54 provided in the paper cassette 46.

In a case that the recording paper P is not accommodated within the paper cassette 46, or the size of the accommodated recording paper P is not a maximum size (in this case, the maximum size is to A4 (length 297 mm, width 210 mm) or a letter size (length 279 nm, width 216 mm)), a message “set A4 or letter size paper to cassette” is displayed on the control panel 58.

Since the image forming apparatus 10 described here is of a compact size used in a personal residence, and the maximum size of the used recording paper P is A4 or letter size, a distance between the registering rolls 49 and the fixing device 38 is set to a dimension in a vertical (longitudinal) direction of the A4 paper or a size in a vertical (longitudinal) direction of the letter size paper.

In a case it is detected that the recording paper P is accommodated within the paper cassette 46 and the accommodated recording paper P is the maximum size, the main motor 50 is driven in accordance with a signal from the control unit 56. Further, one recording paper P is picked up from the paper cassette 46 by the pair of paper feeding rollers 48, and is fed in the paper transport path by the registering rolls 49.

At this time, in the paper wrinkle determination Mode A, an actual printing motion is carried out, and a voltage is applied to the transfer roll 36, however, since an electrostatic latent image of a white date (a data corresponding to a margin (a blank space)) (blank data) is formed on the surface of the image carrier 20, the image is not actually transferred on the recording paper P from the image carrier 20.

Further, the driving of the main motor 50 is stopped at a time when the leading end of the recording paper P (the downstream side end portion in the transporting direction of the recording paper P) is nipped by the heat roll 40 and the pressure roll 42. Accordingly, the recording paper P stops on the paper transport path in a state in which the leading end is nipped by the heat roll 40 and the pressure roll 42 and a rear end (an upstream side end portion in the transporting direction of the recording paper P) is nipped by the registering rolls 49.

When the recording paper P stops on the paper transport path, a message that the cover 14 can be opened and closed is displayed on the control panel 58. In this case, if the user opens the cover 14, a state of the recording paper P on the opened paper transport path is confirmed by the user.

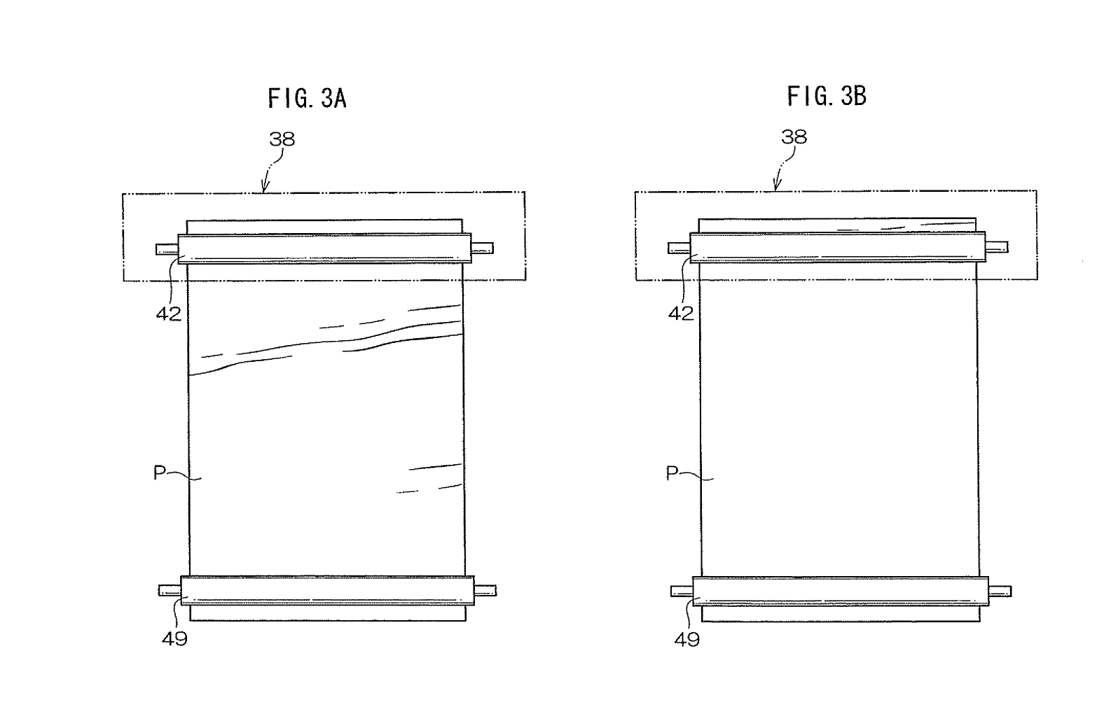

At this time, since the recording paper P enters into the nip portion of the heat roll 40 and the pressure roll 42 of the fixing device 38 only at the leading end thereof if the paper wrinkle is generated in the recording paper P as shown in FIG. 3A, it may be specified that the cause of the paper wrinkle generation exists in the registering rolls 49 (at the image forming apparatus 10 side) such as that the registering rolls 49 are not arranged at the normal position or the like.

Further, since the recording paper P passes through the registering rolls 49 approximately over a whole region thereof except for the rear end thereof, if the paper wrinkle is not generated in the recording paper P as shown in FIG. 3B, it may be specified that the cause of the paper wrinkle generation does not exist in the registering rolls 49, rather, exists in the fixing device 38 such as that the heat roll 40 through which the recording paper P passes in the subsequent process is not arranged at the normal position.

If the cause of the paper wrinkle generation exists in the registering rolls 49 (at the image forming apparatus 10 side), the user may send the image forming apparatus 10 main body to the manufacturer or the store, and if the cause exists in the fixing device 38 side, the user may send only the fixing device 38, by detaching it from the image forming apparatus 10 main body, to the manufacturer or the store.

Accordingly, it is not necessary to send for repair the image forming apparatus 10 main body, which is not necessary to be repaired, for example, in spite of the cause of the paper wrinkle generation existing in the fixing device 38 side.

In the present exemplary embodiment, the description is given of the structure in which whether or not the leading end of the recording paper P reaches the fixing device 38 is detected by counting an elapsed time after detecting the leading end of the recording paper P fed out from the paper cassette 46 by means of the sensor 62 provided near the registering rolls 49 of the paper transport path. However, the structure may be made such as to detect whether or not the leading end of the recording paper P in the transporting direction reaches the registering rolls 49 or the fixing device 38 by counting an elapsed time after the recording paper P is fed out from the paper cassette 46 by means of the pair of paper feeding rollers 48.

Further, in the present exemplary embodiment, the structure is made such as to stop the transport of the recording paper P by stopping driving of the main motor 50 at a time when the leading end of the recording paper P is nipped by the fixing device 38 and the rear end thereof is nipped by the registering rolls 49. However, it is not always necessary to set the state in which the recording paper P is nipped by the fixing device 38 and the registering rolls 49, for example, the structure may be made such as to stop the transport of the recording paper P at a time when the leading end of the recording paper P is nipped by the pair of transport rollers which is located before the fixing device 38 and the rear end thereof is nipped by the paper feeding rollers 48. As mentioned above, the timing for stopping the transport of the recording paper P is not limited to the structure mentioned above.

Next, a description will be given of an image forming apparatus in accordance with a second exemplary embodiment of the invention. In this case, the same reference numerals as the first exemplary embodiment are attached to the same structures as the first exemplary embodiment, and a description thereof will be omitted.

The image forming apparatus in accordance with the second exemplary embodiment is provided with a paper wrinkle Mode B as is different form the image forming apparatus 10 in accordance with the first exemplary embodiment. Further, if the paper wrinkle determination Mode B is executed, presence or not and the size of the recording paper P within the paper cassette 46 are detected by the sensors 52 and 54 provided in the paper cassette 46.

In a case that the recording paper P having a predetermined size (in this case, the predetermined size is set to A4) is not accommodated within the paper cassette 46, a message “paper within cassette is not maximum paper size” is displayed on the control panel 58.

In this case, if the user selects “No”, the paper wrinkle determination Mode B is finished, and if the user selects “Yes”, the main motor 50 is driven on the basis of a signal from the control unit 56. Then, one recording paper P is picked up from the paper cassette 46 by the pair of paper feeding rollers 48 so as to be fed in the paper transport path by the registering rolls 49.

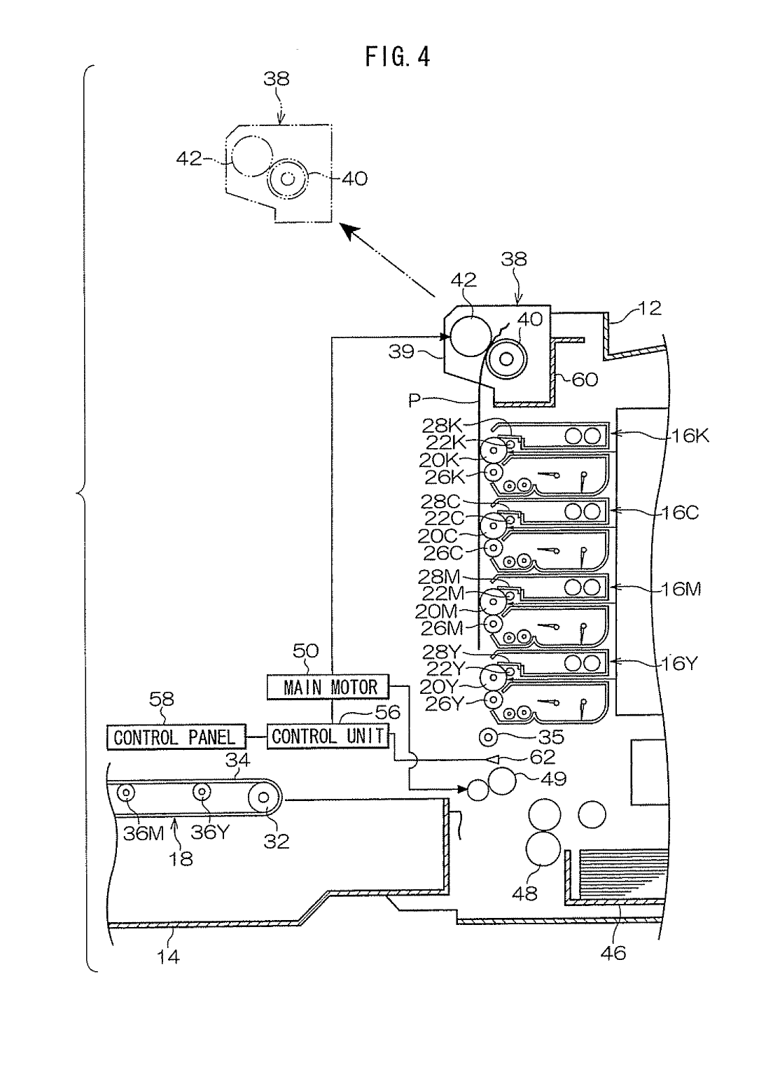

Further, as shown in FIG. 4, the driving of the main motor 50 is stopped at a time when the leading end of the recording paper P is nipped by the heat roll 40 and the pressure roll 42. In this case, since the size (smaller than A4) of the recording paper P is smaller than the distance between the registering rolls 49 and the fixing device 38, the recording paper P stops in a state in which the rear end of the recording paper P has already passed through the registering rolls 49 and has not nipped by the registering rolls 49.

If the recording paper P stops on the paper transport path, a message that the cover 14 can be opened and closed is displayed on the control panel 58. In this case, if the user opens the cover 14, the state of the recording paper P on the opened paper transport path is confirmed by the user.

At this time, since the recording paper P enters into the nip portion of the heat roll 40 and the pressure roll 42 of the fixing device 38 only at the leading end thereof, if the paper wrinkle is generated in the recording paper P, it may be specified that the cause of the paper wrinkle generation exists in the registering rolls 49 (at the image forming apparatus 10 side) such as that the registering rolls 49 are not arranged at the normal position or the like.

Further, since the recording paper P passes through the registering rolls 49 approximately over a whole region thereof, if the paper wrinkle is not generated in the recording paper P, it may be specified that the cause of the paper wrinkle generation does not exist in the registering rolls 49, rather, exists in the fixing device 38 such as that the heat roll 40 through which the recording paper P passes in the subsequent process is not arranged at the normal position.

Next, a description will be given of an image forming apparatus in accordance with a third exemplary embodiment of the invention. In this case, the same reference numerals as the first exemplary embodiment are attached to the same structures as the first exemplary embodiment and the second exemplary embodiment, and a description thereof will be omitted.

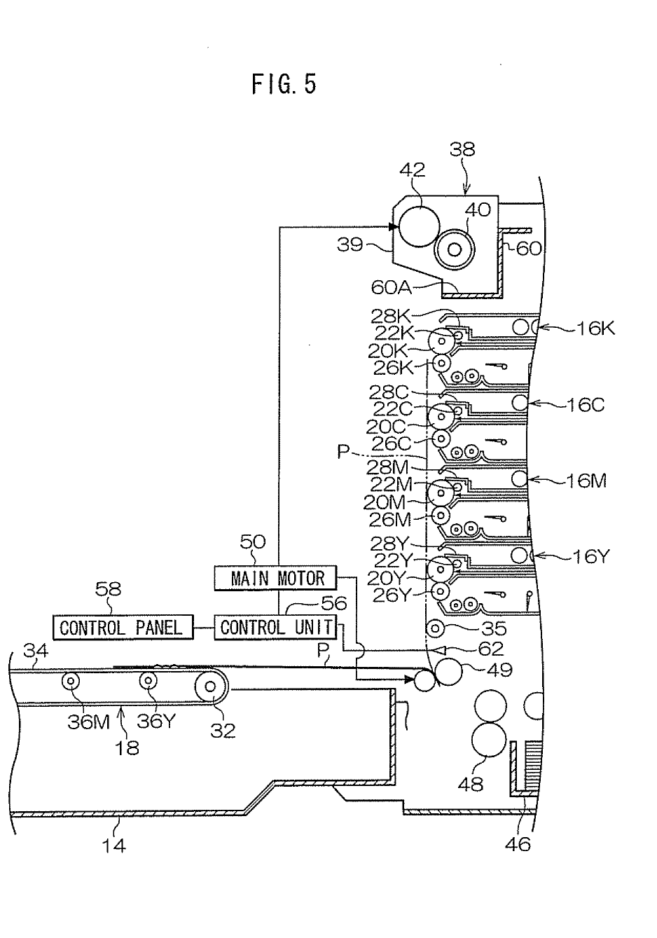

The image forming apparatus in accordance with the third exemplary embodiment is provided with a paper wrinkle Mode C. Further, if the paper wrinkle Mode C is executed, the driving of the main motor 50 is stopped at a time just before the rear end of the recording paper P is released from the registering rolls 49, as shown in FIG. 5.

In this case, since the size of the recording paper P is smaller than the distance between the registering rolls 49 and the fixing device 38, the recording paper P stops in a state in which the leading end of the recording paper P does not enter into the fixing device 38.

If the recording paper P stops on the paper transport path, a message that the cover 14 can be opened and closed is displayed on the control panel 58. In this case, when the user opens the cover 14, the recording paper P is exposed in a state in which the rear end is nipped by the registering rolls 49 and the other portion of the recording paper P is adsorbed to the adsorption transport surface of the transport belt 34. Further, the state of the exposed recording paper P is confirmed by the user.

At this time, since the recording paper P does not enter into the nip portion of the heat roll 40 and the pressure roll 42 of the fixing device 38, if the paper wrinkle is generated in the recording paper P, it may be specified that the cause of the paper wrinkle generation exists in the registering rolls 49 (at the image forming apparatus 10 side) such as that the registering rolls 49 are not arranged at the normal position or the like.

Further, since the recording paper P passes through the registering rolls 49 approximately over a whole region, if the paper wrinkle is not generated in the recording paper P, it may be specified that the cause of the paper wrinkle generation does not exist in the registering rolls 49, rather, exists in the fixing device 38 such as that the heat roll 40 through which the recording paper P passes in the subsequent process is not arranged at the normal position.

Next, a description will be given of an image forming apparatus in accordance with a fourth exemplary embodiment of the invention. In this case, the same reference numerals as the first exemplary embodiment are attached to the same structures as the first exemplary embodiment, and a description thereof will be omitted.

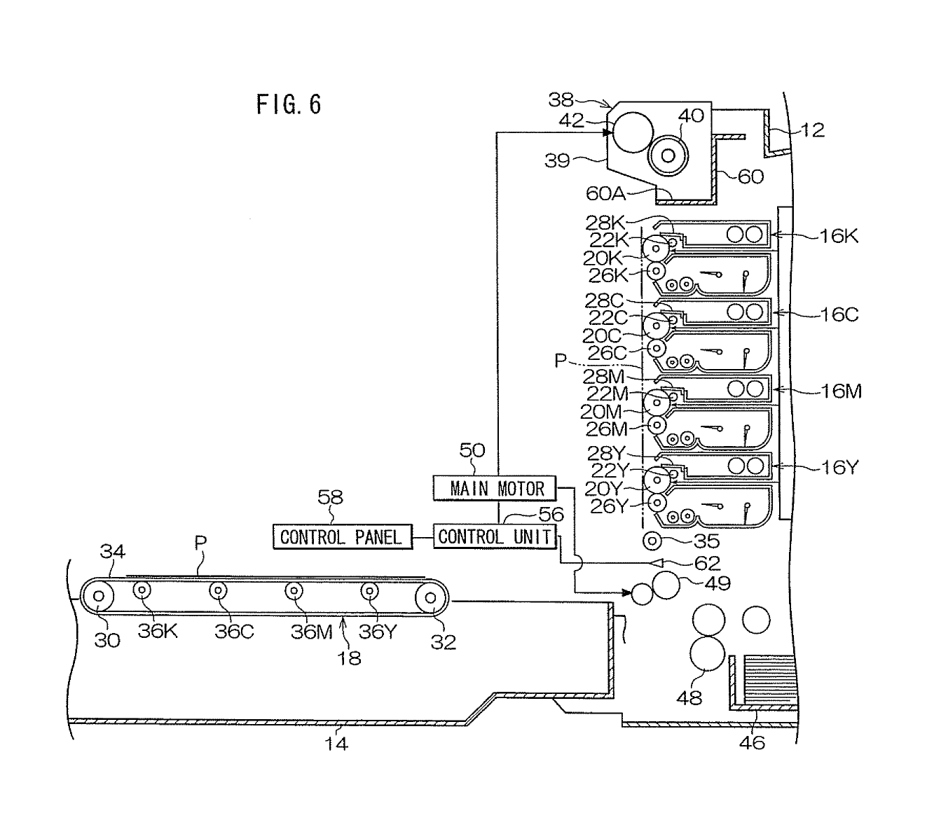

The image forming apparatus in accordance with the fourth exemplary embodiment is provided with a paper wrinkle Mode D. Further, if the paper wrinkle determination Mode D is executed, the driving of the main motor 50 is stopped at a time which is before the leading end of the recording paper P enters into the nip portion of the heat roll 40 and the pressure roll 42 and when the rear end of the recording paper P nipped and transported by the registering rolls 49 is released from the registering rolls 49, as shown in FIG. 6. In other words, the transport of the recording paper P is stopped between the fixing device 38 and the registering rolls 49, in a state in which the leading end is not nipped by the heat roll 40 and the pressure roll 42 and the rear end of the recording paper P is not nipped by the registering rolls 49.

If the recording paper P stops on the paper transport path, a message that the cover 14 can be opened and closed is displayed on the control panel 58. In this case, when the user opens the cover 14, the recording paper P is exposed in a state in which the recording paper P is adsorbed to the adsorption surface of the transport belt 34 which is moved integrally with the cover 14. Further, the state of the exposed recording paper P is confirmed by the user.

At this time, since the recording paper P does not charge into the nip portion of the heat roll 40 and the pressure roll 42 of the fixing device 38, if the paper wrinkle is generated in the recording paper P, it may be specified that the cause of the paper wrinkle generation exists in the registering rolls 49 (at the image forming apparatus 10 side) such as that the registering rolls 49 are not arranged at the normal position or the like.

Further, since the recording paper P passes through the registering rolls 49 over a whole region, if the paper wrinkle is not generated in the recording paper P, it may be specified that the cause of the paper wrinkle generation does not exist in the registering rolls 49, rather, exists in the fixing device 38 such as that the heat roll 40 through which the recording paper P passes in the subsequent process is not arranged at the normal position.

Next, a description will be given of an image forming apparatus in accordance with a fifth exemplary embodiment of the invention. In this case, the same reference numerals as the first exemplary embodiment are attached to the same structures as the first exemplary embodiment, and a description thereof will be omitted.

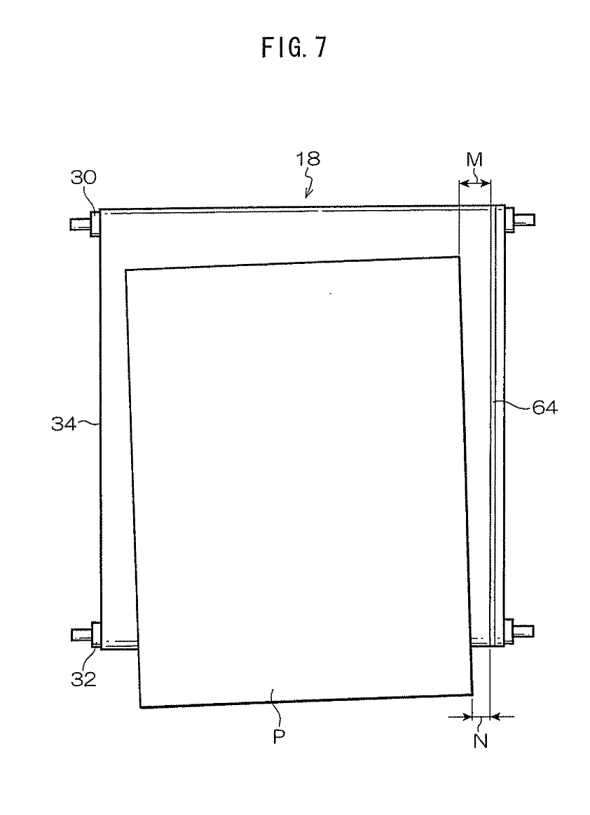

The image forming apparatus in accordance with the fifth exemplary embodiment is provided with a paper wrinkle Mode E. Further, as shown in FIG. 7, a line 64 is provided near one end portion of the transport belt 34 in parallel to the end portion of the transport belt 34 (the transporting direction of the recording paper P). The line 64 is provided so as to be positioned in an outer side than the end portion of the maximum paper size, and is drawn in a white color with respect to the black colored transport belt 34.

If the paper wrinkle Mode E is executed, the driving of the main motor 50 is stopped at a time just before the leading end of the recording paper P enters into the fixing device 38 and in a state in which the rear end of the recording paper P is nipped by the registering rolls 49, and a message that the cover 14 can be opened and closed is displayed on the control panel 58.

In this state, when the user opens the cover 14, the recording paper P is exposed in a state in which recording paper P is adsorbed by the adsorption transport surface of the transport belt 34, because the leading end of the recording paper P is not nipped by the heat roll 40 and the pressure roll 42 of the fixing device 38. Further, the state of the exposed recording paper P is confirmed by the user.

At this time, if the paper wrinkle is generated in the recording paper P, it may be specified that the cause of the paper wrinkle generation exists in the registering rolls 49 (at the image forming apparatus 10 side) such as that the registering rolls 49 are not arranged at the normal position or the like.

Further, since the recording paper P passes through the registering rolls 49 approximately over a whole region, if the paper wrinkle is not generated in the recording paper P, it may be specified that the cause of the paper wrinkle generation does not exist in the registering rolls 49, rather, exists in the fixing device 38 such as that the heat roll 40 through which the recording paper P passes in the subsequent process is not arranged at the normal position.

However, if the recording paper P is loosened or placed bent with respect to the transporting direction at a time point before entering into the fixing device 38, there is a case that the paper wrinkle is generated in the recording paper P entering into the fixing device 38.

Accordingly, the user checks not only whether or not the paper wrinkle is generated in the exposed recording paper P by the cover 14 being opened, but also whether or not the line 64 provided in the transport belt 34 is in parallel to the end portion of the exposed recording paper P by the cover 14 being opened.

In other words, the user checks whether or not a distance M between the leading end portion (the end portion positioned in the driving roll 30 side in the downstream side end portion in the transporting direction) of the recording paper P and the line 64, and a distance N between the rear end portion (the end portion positioned in the driven roll 32 side in the upstream side end portion in the transporting direction) and the line 64 exist within a predetermined range (2 mm in the present exemplary embodiment).

If the paper wrinkle is not generated in the recording paper P, and the distances M and N both exist within the predetermined range, at a time of opening the cover 14 to observe the exposed recording paper P, it may be specified that the cause of the paper wrinkle generation exists in the fixing device 38.

Further, in a case that at least one of the distances M and N does not exist within the predetermined range, it may be specified that the cause of the paper wrinkle generation exists in the registering rolls 49 (at the image forming apparatus 10 side) such as that the registering rolls 49 or the pair of paper feeding rollers 48 are not arranged at the normal position.

In this case, in the present exemplary embodiment, the description is given of the structure in which the line 64 is provided near one end portion of the transport belt 34, however, the lines 64 may be provided in the end portions in both sides of the transport belt 34.

Further, in a case that the distance between the registering rolls 49 and the fixing device 38 is larger than the size in the vertical direction of the used recording paper P, the transport of the recording paper P is stopped between the fixing device 38 and the registering rolls 49. Accordingly, since the recording paper P is exposed in the state in which the recording paper P is adsorbed to the adsorption surface of the transport belt 34 which is moved integrally with the cover 14, at a time of opening the cover 14, it is easy to check the distance between the end portion of the recording paper P and the line.

What is claimed is:

1. An image forming apparatus comprising:
a recording medium transport path along which a recording medium is transported;
a pair of first rollers that are provided at an upstream side in a recording medium transporting direction with respect to the recording medium transport path and that feed the recording medium into the recording medium transport path;
a pair of second rollers that are provided at a downstream side in the recording medium transporting direction with respect to the recording medium transport path and that receive the recording medium transported by the recording medium transport path;
a recording medium transport stopping section that stops transporting of the recording medium on the recording medium transport path; and
a path opening and closing member that opens the recording medium transport path.

2. The image forming apparatus of claim 1, wherein when the dimension of the recording medium in the transporting direction is larger than a distance between the pair of first rollers and the pair of second rollers, the recording medium transport stopping section stops transporting of the recording medium by nipping the recording medium with the pair of first rollers and the pair of second rollers.

3. The image forming apparatus of claim 1, wherein when the dimension of the recording medium in the transporting direction is smaller than a distance between the pair of first rollers and the pair of second rollers, the recording medium transport stopping section stops transporting of the recording medium by nipping the recording medium with one of the pair of first rollers or the pair of second rollers.

4. The image forming apparatus of claim 1, wherein when the dimension of the recording medium in the transporting direction is smaller than a distance between the pair of first rollers and the pair of second rollers, the recording medium transport stopping section stops transporting of the recording medium at a position between the pair of first rollers and the pair of second rollers.

5. The image forming apparatus of claim 1, wherein:
the path opening and closing member includes a cover that is capable of being opened and closed with respect to a main body of the image forming apparatus, and includes an endless transport belt that is wound around a pair of support rolls provided so as to be along the transporting direction of the recording medium in a state in which the cover is closed, and is provided at the cover,
the recording medium transport path is configured with the transport belt in a state in which the cover is closed, and a roll that is arranged so as to face to the transport belt,
the recording medium transport path is opened due to the transport belt being separated from the roll, integrally with the cover, when the cover is opened.

6. The image forming apparatus of claim 5, wherein a line that is along the transporting direction is provided at least one end portion, in a direction orthogonal to the transporting direction of the recording medium, of the transport belt.

7. The image forming apparatus of claim 5, wherein the roll is an image carrier from which a toner image is transferred onto the recording medium.

8. The image forming apparatus of claim 1, wherein the recording medium transport stopping section includes a sensor that detects the recording medium, the sensor being provided to the downstream side in the recording medium transporting direction with respect to the pair of first rollers.

9. The image forming apparatus of claim 1, wherein the pair of second rollers is provided at a main body of the image forming apparatus so as to be attachable to and detachable from the main body.

10. The image forming apparatus of claim 1, wherein
a device check operation is operatable in the image forming apparatus, and
in the device check operation, after a process, which is before a process at which the pair of second rollers are used, is carried out on the base of blank data, the recording medium transport stopping section stops transporting of the recording medium on the recording medium transport path.

11. The image forming apparatus of claim 10, wherein
the recording medium transport path is configured with a transport belt that transports the recording medium and an image carrier on which a latent image is formed, and
after the latent image being formed on the image carrier and a transferring process from the image carrier to the recording medium being carried out on the basis of the blank data, the recording medium transport stopping section stops transporting of the recording medium on the recording medium transport path.

12. The image forming apparatus of claim 11, wherein the device check operation is an operation for judging cause of generation of wrinkle on the recording medium.

13. The image forming apparatus of claim 11, wherein a toner image is not formed on the recording medium at the transferring process.
